(19) United States
(12) Patent Application Publication
(10) Pub. No.: US 2024/0023534 A1
(43) Pub. Date: Jan. 25, 2024

(54) Devices, Compositions and Methods for Insect Control

(71) Applicants: Agriculture Victoria Services PTY LTD, Bundoora, VICTORIA (AU); Horticulture Innovation Australia Limited, Sydney NSW (AU)

(72) Inventors: Kevin Farnier, Mill Park (AU); John Cunningham, Ivanhoe (AU); Farrukh Baig, Multan (PK)

(73) Assignees: Agriculture Victoria Service PTY LTD, Bundoora, VICTORIA (AU); Horticulture Innovation Australia Limited, Sydney NSW (AU)

(21) Appl. No.: 18/266,037

(22) PCT Filed: Mar. 17, 2021
(86) PCT No.: PCT/AU2021/050240

§ 371 Date: Jun. 8, 2023

(30) Foreign Application Priority Data
Dec. 9, 2020 (AU) 2020904575

(51) Int. Cl. A01M 1/02; A01P 19/00; A01N 25/04; A01N 63/32; A01N 37/02; A01M 1/10; A01N 31/02; A01N 35/02

(52) U.S. Cl. CPC A01M 1/026; A01P 19/00; A01N 25/04; A01N 63/32; A01N 37/02; A01M 1/103; A01N 31/02; A01N 35/02

(57) ABSTRACT

The present invention relates to compositions and devices for attracting, trapping and/or monitoring insects, more particularly Carpophilus beetles, such as stone fruit beetle and almond beetle. The described compositions and devices include novel mixtures for attracting Carpophilus beetles, including compositions for selectively attracting and trapping specific species of Carpophilus beetle.

### FIELD OF THE INVENTION

The present invention relates to devices, compositions and methods for insect control, more particularly the present invention relates to multicomponent compositions used in combination with devices for releasing said composition, and devices employing said composition for attracting, trapping and/or monitoring insects, more particularly Carpophilus beetles, such as stone fruit beetle and almond beetle.

### BACKGROUND OF THE INVENTION

The current commercial lure used in “attract and kill” for the stone fruit beetle is composed of (i) a chemical blend derived from fermenting fruit odours (commonly referred to as a ‘co-attractant’) applied in solution and (ii) a three-species synthetic aggregation pheromone mix (C. davidsoni, C. mutilatus and C. hemipterus) loaded on a rubber septum. These two odours work synergistically to attract the beetle.

The original co-attractant was developed based on fermenting peach juice, and comprises six constituents: acetaldehyde, ethyl acetate, ethanol, isobutyl alcohol, isopentyl alcohol and 2-methylbutanol prepared in aqueous solution. This co-attractant mixture has been shown to be effective against a wide range of Carpophilus beetles attacking stone fruits.

However, lure longevity of the current co-attractant has proved to be problematic, with emission rates of some key attractants dropping off in some instances within a day after lure deployment in the field. Targeting specific beetle species has also been shown as an issue, as generalised compositions may not achieve the desired results to attract and kill insects of a particular species, and thereby showing a reduced efficacy in protection of said crop.

There exists a need to overcome, or at least alleviate, one or more of the difficulties or deficiencies associated with the prior art.

### SUMMARY OF THE INVENTION

In one aspect of the present invention there is provided a composition for attracting Carpophilus beetles, said composition including:
ethanol, and
a co-attractant mixture including one or more compounds selected from acetaldehyde, ethyl acetate, isobutanol, isopentyl alcohol, and 2-methylbutanol, wherein said composition is a liquid and/or gas mixture.

By the term ‘composition’ as used herein is meant a mixture of additives which may be in the form of a liquid, gas, vapour or any other suitable phase mixture thereof which is capable of attracting Carpophilus beetles.

In a preferred embodiment the co-attractant mixture includes one or more compounds selected from:
acetaldehyde at a concentration of between approximately 5 μl and 170 μl/100 ml of composition, more preferably between approximately 50 μl and 70 μl/100 ml
ethyl acetate at a concentration of between approximately 75 μl and 125 μl/100 ml of composition, more preferably between approximately 100 μl and 110 μl/100 ml
isobutanol at a concentration of between approximately 0.1 μl and 50 μl/100 ml of composition, more preferably between approximately 15 μl and 40 μl/100 ml
2-methyl-butanol at a concentration of between approximately 0.1 μl and 40 μl/100 ml of composition, more preferably between approximately 15 μl and 30 μl/100 ml
isopentyl alcohol at a concentration of between approximately 0.01 μl and 1750 μl per 100 ml of composition, more preferably between approximately 400 μl and 1500 μl/100 ml.

In a preferred embodiment the composition further includes one or more fungal additives. By the term ‘fungal additive’ as used herein is meant any compound that is identical to a compound that a fungus is capable of producing. A fungal additive included in the composition described herein may be isolated or collected from a fungus, or be a synthetic copy and/or analogue thereof. For example, the compound may be a small organic molecule, say an alcohol, ester, or one of a mixture of volatiles. In a further preferred embodiment, the one or more fungal additives are identical to compounds produced by a yeast, preferably a yeast of the genus Wickerhamomyces, Pichia or Hanseniaspora and more preferably a yeast of the species Wickerhamomyces rabaulensis, Pichia kluyveri or Hanseniaspora guillermondii. In a particularly preferred embodiment, the one or more fungal additives are volatile organic compounds, preferably selected from the group consisting of isobutyl acetate, isopentyl acetate, 2-phenylethylpropionate, and 2-phenethyl acetate.

The amount of any given fungal additive in the composition may vary and may be dictated by the particular application at hand and the identity of the compound. However, generally, speaking, in a preferred embodiment the composition includes one or more fungal additives at a concentration of between approximately 0.001 μl and 250 μl/100 ml of composition, preferably between approximately 10 μl and 100 μl/100 ml.

For example, in preferred embodiments where the one or more fungal additives are selected from the group consisting of isobutyl acetate, isopentyl acetate and 2-phenethyl acetate, the amount of fungal additive in the composition may be selected from:
isobutyl acetate at a concentration of between approximately 0.05 μl and 5 μl/100 ml of composition, more preferably between approximately 0.1 μl and 20 μl/100 ml;
isopentyl acetate at a concentration of between approximately 0.01 μl and 150 μl/100 ml of composition, more preferably between approximately 0.1 μl and 20 μl/100 ml; or
2-phenethyl acetate at a concentration of between approximately 15 μl and 30 μl/100 ml of composition, more preferably between approximately 5 μl and 50 μl/100 ml.

In a preferred embodiment, the fungal additive(s) and co-attractant mixture are present in the composition at a ratio of between approximately 1:2 and 1:100 (v/v); more preferably between approximately 1:2 and 1:8 v/v.

The ethanol may be present in its neat form or with a releasing carrier. The carrier may be for example a solid, semi-solid or liquid. For example, the carrier may be aqueous, such that the ethanol is present in an aqueous mixture. In a preferred embodiment, the composition includes ethanol in an aqueous ethanol mixture. In a further preferred embodiment, the aqueous ethanol mixture comprises between approximately 30 to 85% ethanol, more preferably between approximately 35 to 65% ethanol, and most preferably approximately 45% ethanol.

By the term ‘aqueous’ as used herein is meant a water-based solvent, preferably including at least approximately 40% water, preferably distilled water, and may include other water-soluble or -miscible components.

In an alternatively preferred embodiment, the releasing carrier is a solid or semi-solid, preferably a matrix or gel. Preferably, the composition includes ethanol present in a gel.

In a preferred embodiment, the Carpophilus beetle may be a stone fruit beetle or almond beetle. In a particularly preferred embodiment the Carpophilus beetle is of a species selected from the group consisting of Carpophilus davidsoni, Carpophilus hemipterus, Carpophilus humeralis, Carpophilus truncatus “almond beetle” (synonymous with Carpophilus jarijari and Carpophilus near dimidiatus).

The present inventors have found that a composition which contains ethanol and isopentyl alcohol selectively attracts Carpophilus truncatus (almond beetle) species beetles over other Carpophilus species beetles.

Accordingly, in a preferred embodiment the present invention provides a composition including ethanol and isopentyl alcohol which selectively attracts C. truncatus over other Carpophilus species. In a further preferred embodiment there is provided a composition including ethanol and isopentyl alcohol which selectively attracts C. truncatus over other Carpophilus species, wherein the concentration of isopentyl alcohol is between approximately 0.01 μl and 1750 μl/100 ml of composition, more preferably wherein the concentration of isopentyl alcohol is between approximately 400 μl and 1500 μl/100 ml of composition, most preferably wherein the concentration of isopentyl alcohol is approximately 800 μl/100 ml of composition.

In a preferred embodiment there is provided a composition for attracting Carpophilus beetles, said composition including acetaldehyde, ethanol, ethyl acetate, isobutanol, isopentyl alcohol, 2-methyl-butanol and 2-phenylethyl acetate.

In a preferred embodiment there is provided a composition for attracting Carpophilus beetles, said composition including acetaldehyde, ethanol, isobutanol, isopentyl alcohol, 2-methyl-butanol, isopentyl acetate and isobutyl acetate.

In a preferred embodiment there is provided a composition for attracting Carpophilus beetles, said composition including acetaldehyde, ethanol isobutanol, isopentyl alcohol and 2-methyl-butanol, and wherein said composition does not include ethyl acetate.

The compositions as described herein do not exclude addition of further additives or excipients for producing a composition, apparatus or deceive suitable for attracting trapping or monitoring stone fruit beetles.

In another aspect of the present invention there is provided an apparatus for dispensing a composition as described herein. In a preferred embodiment the apparatus provides for regulated release of the composition. In a particularly preferred embodiment the apparatus provides for regulated release of the composition for between approximately 1 to 6 weeks, more preferably between approximately 1 to 4 weeks.

In a preferred embodiment there is provided an apparatus for dispensing a composition as described herein, wherein the apparatus includes:
at least one deposit element for storage of a composition, and
at least one casing for housing a deposit element,
   wherein the deposit element releases the composition and the casing provides a means for release of the composition into the surrounding environment.

By a deposit element as used herein is meant any suitable substance in which the composition can be stored and released from. In an embodiment, the deposit element may be a cotton roll/dental wick or any other such substance suitable for storage and release of the composition.

By a casing as used herein is meant any suitable substance capable of storing the deposit element, such that it is capable of allowing for release of the composition stored within the deposit element to the surrounding environment external to the casing. The release of said composition from the casing may be either passive or active.

In a preferred embodiment the apparatus provides for each compound, of the composition as described herein, to be is stored within a separate deposit element.

In a preferred embodiment the apparatus as described herein includes a casing made of low density polyethylene. Preferably the casing is made of low density polyethylene having a thickness of between approximately 25 μm to 250 μm, more preferably between approximately 35 μm to 225 μm. In a particularly preferred embodiment the casing is made of low density polyethylene having a thickness of between approximately 50 μm to 200 μm.

In a preferred embodiment there is provided an apparatus for attracting Carpophilus beetles, said apparatus including:
a composition including one or more compounds selected from the group consisting of acetaldehyde, ethyl acetate, isobutyl alcohol, isopentyl alcohol, 2-methylbutanol, isobutyl acetate, isopentyl acetate and 2-phenethyl acetate;
a liquid ethanol source;
at least one deposit element for storage of the composition; and
at least one casing for housing a deposit element, wherein each deposit element releases the one or more compounds and the casing provides a means for release of the composition into the surrounding environment.

In a preferred embodiment there is provided a device for trapping Carpophilus beetles, said device including a composition as described herein.

In a preferred embodiment there is provided a device for trapping stone fruit beetles, said device including an apparatus as described herein.

In a preferred embodiment there is provided a method of attracting and/or trapping stone fruit beetles including the step of exposing a Carpophilus beetle infested environment to a composition, apparatus, and/or device as described herein.

In a preferred embodiment there is provided a method of monitoring for the presence of at least one stone fruit beetle including positioning a composition, an apparatus, or a device as described herein, within an environment that requires monitoring for the presence of stone fruit beetles.

In this specification, the term ‘comprises’ and its variants are not intended to exclude the presence of other integers, components or steps.

In this specification, reference to any prior art in the specification is not and should not be taken as an acknowledgement or any form of suggestion that this prior art forms part of the common general knowledge in Australia or any other jurisdiction or that this prior art could reasonably expected to be combined by a person skilled in the art.

The present invention will now be more fully described with reference to the accompanying Examples and drawings. It should be understood, however, that the description following is illustrative only and should not be taken in any way as a restriction on the generality of the invention described above.

### BRIEF DESCRIPTION OF THE DRAWINGS/FIGURES

FIG. 1. A sachet dispenser, comprising a heat-sealed low density polyethylene (LDPE) sachet (10) with composition infused wick (20).

FIG. 2. Release rates using different sachets/components combinations to reproduce the odour of the commercial stone fruit carpophilus co-attractant lure. Ethanol exhibited limited permeation through the LDPE layers and was therefore tested in vials with perforated lids (holes of different diameters).

FIG. 3. SPME-GC-MS chromatograms of the commercial carpophilus co-attractant in solution (B) and co-attractant in sachets (A). Peak numbering corresponds to the following lure components: 1. acetaldehyde, 2. ethyl acetate, 3. ethanol, 4. isobutyl alcohol, 5. Isopentyl alcohol and 6. 2-methylbutanol.

FIG. 4. Results of field trials comparing stone fruit beetle catches using the carpophilus lure, CL (without aggregation pheromone) formulated in solution or LDPE sachets. Grey bars represent the mean cumulated catch of stonefruit beetles (C. davidsoni, C. hemipterus and C. humeralis) per trap over the 2 week period of the trial and error bars show the standard error. Lettering above bars show statistical differences between treatments.

FIG. 5. Field trapping of C. davidsoni using yeasts Pichia kluyveri (Pk), Hanseniaspora guilliermondii (Hg) broth, or sterile Sabouraud dextrose broth control (C). N=20. Letters above bars indicate statistical differences between treatments.

FIG. 6. GC-EAD responses of female (♀) and male (♂) C. davidsoni adults to headspace volatiles (black, FID chromatogram) of the fruit yeast Pichia kluyveri. Dashed lines indicate consistent physiological responses elicited in beetles antennae and their corresponding chromatographic peaks annotated as follows: 1) ethyl acetate, 2) Isobutyl alcohol, 3) Propyl acetate, 4) Isopentyl alcohol, 5) 2-methyl-1-butanol, 6) Isobutyl acetate, 7) Butyl acetate, 8) Isopentyl acetate, 9) 2-furanmethanol acetate, 10) γ-caprolactone, 11) Phenylmethyl acetate, 12) Ethyl octanoate, 13) 2-phenylethyl acetate and 14) 2-phenylethylpropionate. IS=Internal standard, IS1=n-octane, IS2=Nonyl acetate.

FIG. 7. SPME-GC-MS chromatograms of the headspace of the yeast Pichia kluyveri in potato dextrose broth. The odour profile is less complex with less peaks than that of the same yeast grown on peach agar medium. The production of acetaldehyde and ethanol covered by the solvent peak in GC-EAD recordings is made visible by the use of SPME for volatiles sampling.

FIG. 8. C. davidsoni catches using prototype co-attractant solutions in a stone fruit orchard (Shepparton, VIC). CL corresponds to the control (original Carpophilus Lure co-attractant), CL+IA (co-attractant+Isopentyl Acetate), CL+PA (co-attractant+2-Phenethyl acetate) and CL+IA+PA (co-attractant+Isopentyl Acetate+2-Phenethyl acetate). Letters above bars indicate statistically significant differences. Number of replicates per treatment N=6.

FIG. 9. Boxplots representing the results of lab-conducted cage dual-choice assays on Carpophilus truncatus responses to odours. Between 50 and 100 beetles were simultaneously exposed to a solution of co-attractant and a solution of co-attractant (control) from which one ingredient at a time was suppressed (treatments). The attraction index was calculated as follows: (number of beetles in test solution−number of beetles in control)/(total number of beetles). Hence, positive indices indicate preferences for the test solution whilst negative indices indicate preference for the control (original carpophilus co-attractant). Line in the boxplots correspond to the median, top and bottom of the boxplots represent the 75th and 25th percentiles respectively while error bars depict the 5th and 95th percentiles. White dots are outliers. n correspond to the replication of each experiments. p values result from paired t-tests and stars indicate the level of statistical significance.

FIG. 10. GC-EAD responses of C. truncatus to a W. rabaulensis synthetic odour blend. 1-Acetaldehyde. 2-Ethanol. 3-Isobutanol. 4-Isopentyl alcohol. 5-2-Methyl butanol. 6-Isobutyl acetate. 7-Isopentyl acetate.

FIG. 11. Results of field testing results assessing new co-attractants (with Isopentyl alcohol). The original co-attractant treatment (CL) was used as control for comparison with the prototypes. Grey bars show the mean weekly catch of C. truncatus per trap over, white bars represent other species (mostly C. davidsoni, C. hemipterus and C. humeralis). Each treatment was replicated 12 times (6 reps at two field sites). Error bars represent the standard error. Upper and lower case letterings above bars depict respectively the statistical differences between C. truncatus and other carpophilus species catches using different test solutions.

FIG. 12. Results of field tests assessing new co-attractant solutions (with Isopentyl alcohol). The best performing lure in previous trial (Isopentyl alcohol*2—Example 8) was used as control for comparison with other prototypes. Black bars show the mean cumulated catch of C. truncatus per trap over duration of the phase whereas grey bars represent that of other species (mostly composed of C. davidsoni, C. hemipterus and C. humeralis). Treatments were replicated 12 times in total (6 reps in two field sites). Error bars represent the standard error. Upper case lettering above bars depicts statistical differences between C. truncatus catches using different test lures and lower case, those of the other carpophilus species.

FIG. 13. Results of field assessment testing different concentrations of ethanol used in the simplified co-attractant (“Ref”; See table 6) Grey bars show the mean weekly catch of C. truncatus per trap over the duration of the trial and the white bars that of other carpophilus species. Treatments were replicated 10 times in total (5 reps in two field sites). The error bars represent the standard error. Lower case lettering above bars are statistical differences between C. truncatus catches using different test lures and the upper case ones, those of the other carpophilus species.

FIG. 14. Results of field assessment of microbial-derived odour blends. CL corresponds to the original carpophilus co-attractant chosen (control). Black bars show the mean cumulated catch of C. truncatus per trap over the duration of the trial and the grey ones that of other carpophilus species. Treatments were replicated 12 times in total (6 reps in two field sites). The error bars represent the standard error. Upper case lettering above bars are statistical differences between C. truncatus catches using different test lures and the lower case one, those of the other carpophilus species.

FIG. 15. Result of field assessment of microbial-derived odour blends. CL corresponds to the original carpophilus food attractant chosen as control in this experiment. Black bars show the mean cumulated catch of C. truncatus per trap over duration of the phase whereas grey bars represent that of other species (mostly composed of C. davidsoni, C. hemipterus and C. humeralis). Treatments were replicated 10 times in total (5 reps in two field sites). The error bars represent the standard error. Upper case lettering above bars depicts statistical differences between C. truncatus catches using different test lures and the lower case one, those of the other carpophilus species.

FIG. 16. Results of a field trial in an almond orchard demonstrating that a simple co-attractant blend of isopentyl alcohol and ethanol (“Ref”; see table 9) is significantly more attractive than co-attractant blends with ethyl acetate and other yeast odours. Changes in the concentrations of ethyl acetate and yeast esters did not significantly influence C. truncatus attraction (grey bars). The lower catches of non-target species in all treatments involving the Ref solutions indicate that a strong synergism between acetaldehyde (absent in Ref) and ethyl acetate mediate the attraction of other non-target carpophilus (white bars). Lower case and capital letters above bars indicate statistically different weekly catches among treatments for C. truncatus and other non-target species, respectively. Error bars represent the standard errors. Each treatment was replicated 12 times split between two blocks and tested in the field for 7 weeks in Carina (30 January-11 March).

FIG. 17. Results of a field trial in an almond orchard showing that the new co-attractant blend of isopentyl alcohol and ethanol (“Ref”; see table 10) catches between 8 and 10 times more C. truncatus (grey bars) than the commercial solution (CL). In addition, the new attractant exhibits a greater specificity reflected in significantly lower catches of non-target Carpophilus species (white bars) than with the old co-attractant. Lower case and capital letters above bars indicate statistically different weekly catches among treatments for C. truncatus and other non-target species, respectively. Error bars represent the standard errors. Each treatment was replicated 12 times split between two blocks and tested in the field for 4 weeks in Carina (25 March-15 April).

FIG. 18. Results of a field trial in an almond orchard testing the use of different concentrations of isopentyl alcohol in the simplified co-attractant (“Ref”; see table 11). Grey bars represent C. truncatus weekly capture and white bars that of other carpophilus species. Error bars correspond to the standard error. Lower case and capital letters above bars indicate statistically different weekly catches among treatments for C. truncatus and other non-target species, respectively. The simplified co-attractant tends to catch more beetle when its isoamyl alcohol concentration is doubled (Ref×2) while significantly lower catches are obtained when the concentration of isopentyl alcohol was tripled (Ref×3). Each treatment was replicated 12 times split between two blocks and tested in the field for 4 weeks in Carina (25 March-15 April).

### DETAILED DESCRIPTION OF THE EMBODIMENTS

### Example 1—Development of the New Lure Dispensers

The original co-attractant was developed based on fermenting peach juice, and comprised six constituents: acetaldehyde, ethyl acetate, ethanol, isobutyl alcohol, isopentyl alcohol and 2-methylbutanol prepared in aqueous solution according to the method described by Bartelt and Hossain 2006.

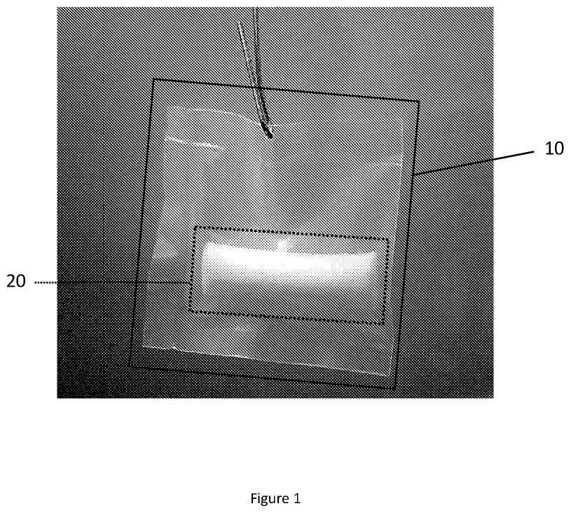

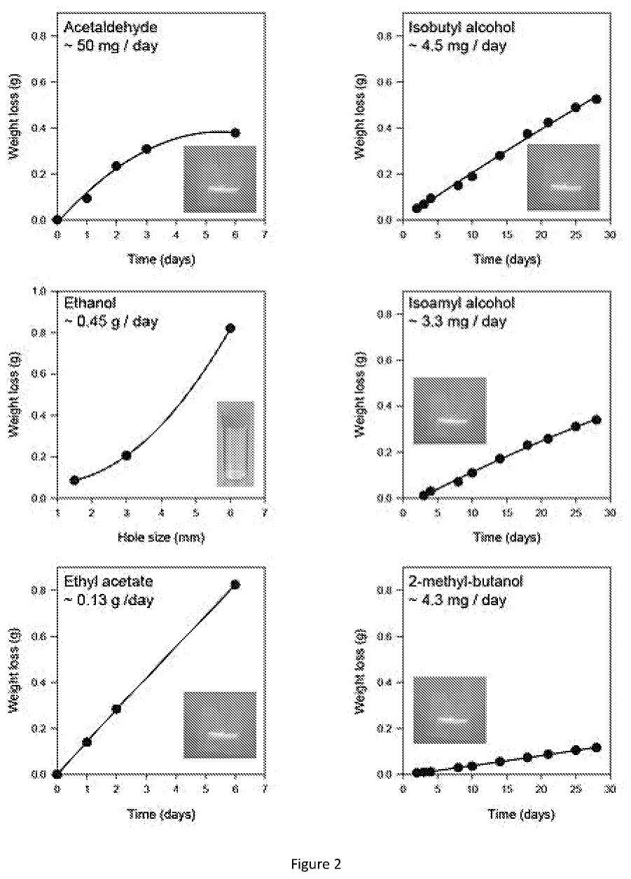

The release rates of co-attractant components formulated in low density polyethylene (LDPE) sachets were investigated (FIG. 1). All compounds except ethanol were found to permeate through the plastic membranes of the dispensers at comparable rates to those of the original co-attractant, but lasting for a significantly prolonged period of time. For instance, the release of highly volatile compounds such as ethyl acetate and acetaldehyde are extended from 1 day in the current solution to 1 week when applied in sachets (FIG. 2).

The release rate and theoretical longevity of the lure constituents in sachets were tested in gravimetric experiments. Data were used to determine the optimal sachet thickness, size (surface area) and estimated longevity of individual components (FIG. 2).

A fixed volume (1 ml) of each lure constituent was individually loaded in 50 cm 2 of different thicknesses (50, 100, 150 and 200 μm). Sachets were weighed daily for the first 5 days and later at greater time intervals. Release rates of the compounds through different sachet thicknesses were inferred using sachet weight loss over time (FIG. 2). Only the linear part of the weight loss curve was considered in the calculations of release rates. The maximum estimated longevity was deduced from the calculated release rate and corrected based on adjusted sachet size and volume of chemical loaded.

Of all compounds, only ethanol could not be formulated in sachets. Lab experiments showed that the maximum release rate achievable with thin sachets was in the 25 mg/day range; about a hundred times less than ethanol emission rates in the commercial lure (2.5 g/day). In addition, the results of pilot testing under laboratory conditions suggest that equal emission rates and longevity could be achieved using ethanol gel instead of ethanol in solution.

TABLE 1
Combinations of different sachets used to recreate the
odour of the original carpophilus co-attractant solution.

| | | | | | | Release rate |
|---|---|---|---|---|---|---|
| | | | Load | Est. long. | Release rate | (commercial solution) |
| Compound | Thickness (μm) | Size (cm) | (ml) | (days) | (mg/day) | (mg/day) |
| acetaldehyde | 200 | 5 × 2.5 | 2 | 7 | 50 | 43 |
| ethyl acetate | 200 | 5 × 5 | 2 | 15 | 136 | 110 |
| Isobutyl alcohol | 50 | 2.5 × 2.5 | 1 | 200+ | 4.9 | 2.9 |
| Isopentyl alcohol | 50 | 2.5 × 2.5 | 1 | 300 | 3.4 | 3.3 |
| 2-methyl-butanol | 100 | 5 × 5 | 1 | 200+ | 4.3 | 0.6 |

Notes:
In grey: release rates of compounds in commercial solution
Compositions loaded on a wick and sealed within the sachet.
Ethanol cannot be formulated in sachet and is instead applied as a 45% solution (200 ml) in 11 cm diameter plastic container.

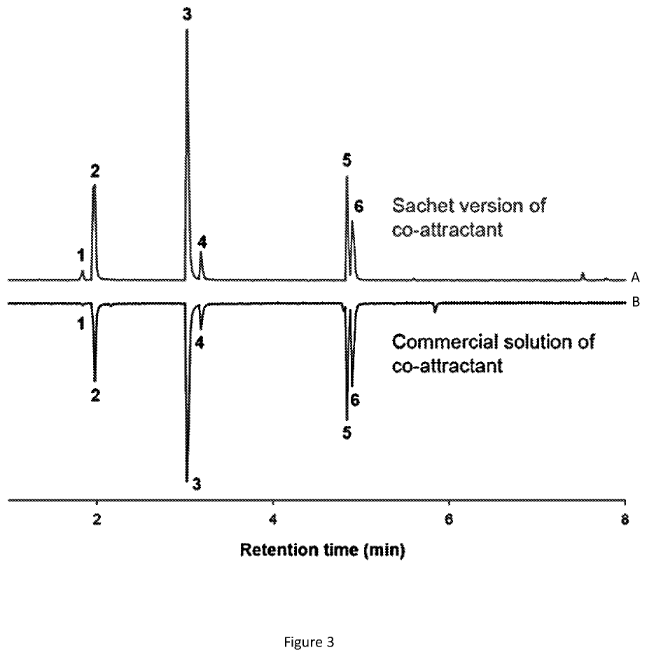

The similarity between the solution and sachet version of the co-attractant was confirmed by Solid-phase microextraction (SPME) sampling and GC-MS-FID analysis. (FIG. 3).

### Example 2—Field Studies of Sachet Lures

Lures in sachets were tested in an almond orchard in a trial that initially aimed to compare the attraction of the nut beetle C. truncatus to the commercial (stone fruit beetle) co-attractant, formulated in solution and sachets. However, as populations of stone fruit beetles (both C. davidsoni and C. hemipterus) were also present, this enabled data on sachet effectiveness to be collected for these species.

Lures were tested in black funnel traps (23×17 cm, Bioglobal, Queensland, Australia), held in a metal ring fixed to a metal fence picket at 1.5 m height. A piece of insecticide (3×2 cm, dichlorovos) impregnated plastic strip was placed inside the traps to kill captured beetles. 200 ml of commercial lure or 45% ethanol (used with sachets) solutions was placed in open plastic containers (11.0 cm diameter) covered with mosquito netting. Sachets were suspended inside the traps by means of paperclips. Traps baited with different lures were arranged in a randomized block complete with a minimum of 30 m spacing between traps. Traps were serviced, trapped beetles collected, and lures replaced, weekly.

Over a two-week period, the sachet lures caught significantly more beetles than the same lure formulated in solution. C. hemipterus made up the vast majority of the beetles caught, with few C. davidsoni present in traps. C. hemipterus, prefers decaying fruits and is therefore considered more a nuisance than a pest. By contrast, C. davidsoni attack ripening fruits and cause significant crop damage. Both species are known to be strongly attracted to the carpophilus lure. The predominance of C. hemipterus in this specific trial may reflect an existing bias in the resident beetle population in the almond orchard.

### Example 3—Field Studies of Sachet Lures

The useability and effectiveness of the co-attractant formulated in sachets was field tested in December 2019 at two almond orchards located near Mildura, Victoria. A freshly prepared co-attractant solution was used as a control (i.e. no dispensers), and ethanol was dispensed in different ways across treatments, i.e. in plastic vials, in solution or both. Traps were arranged in a 6×4 randomized complete block design replicated at both sites (n=12). Beetles were collected and the lures replaced after one week.

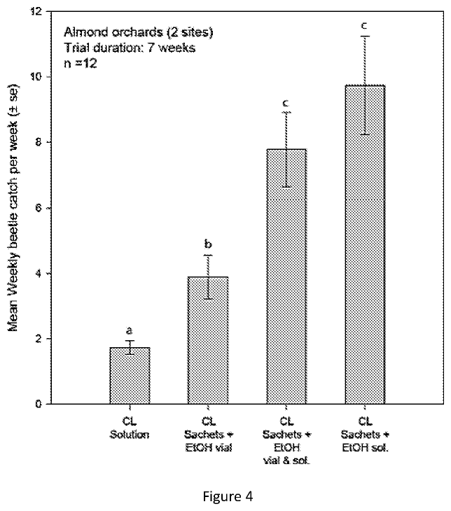

Stone fruit beetles are often found in almond orchards in spring. The trial aimed to test lure effectiveness with the nut beetle C. truncatus, with the results revealing an impact of the sachets on the stone fruit pests, C. davidsoni, C. hemipterus and C. humeralis catches.
Treatments comprising co-attractant components in sachets caught significantly more beetles than the co-attractant in solution.
Greatest catches were obtained when sachets were applied with ethanol in solution as opposed to in vials or vials and solution simultaneously; reaching up to 8 times more the number of beetles caught with the co-attractant solution (FIG. 4).

### Example 4—Identification and Testing of 2-Phenylethylacetate as a New Co-Attractant Component for Carpophilus Attacking Stone Fruit

Our laboratory studies investigating the influence of yeasts on carpophilus oviposition and larval development suggest that fruit microbiome plays a crucial role in beetle survival: C. davidsoni pupal mass, survival to adulthood was found to be greater on fruit media inoculated with Pichia kluyveri and their development time shorter compared to when the same medium was inoculated with Hanseniaspora guillermondii; another yeast isolated from the guts of wild caught beetles (Baig et al. 2020).

### Attraction of Stone Fruit Attacking Carpophilus to Yeast Odours in Field Studies

Beetle attraction to yeast volatiles was tested in a stone fruit orchard in Bunbartha (Northern Victoria). Volatiles were applied in the form of high-density yeast cultures of the two gut-associated yeasts P. kluyveri and H. guillermondii prepared in a potato dextrose broth, while a sterile potato broth was used as procedural control. Twenty replicates of each treatments placed in McPhail traps with a cube of insecticide were hung in trees in randomized transects with a 7 m minimum distance between traps. Beetles were collected and yeast broth was replaced weekly.

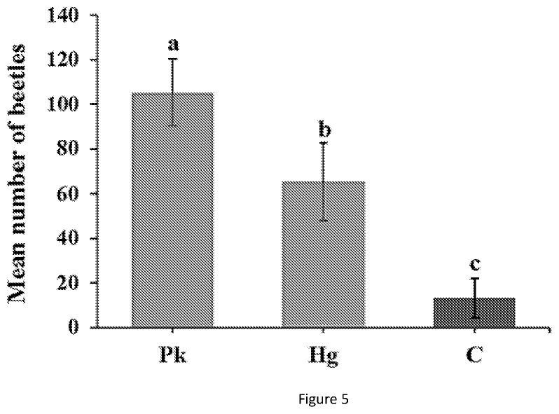

In line with lab performance studies, traps baited with P. kluyveri attracted significantly more beetles than those baited with H. guillermondii and sterile broth (FIG. 5).

### Example 5—Identification and Comparison of Yeast Odour Actives

P. kluyveri and H. guillermondii volatiles were collected and analysed by GC-MS. Statistical analysis indicated that 70% of the dissimilarity between the two yeast odours was linked to two chemicals: Isopentyl acetate and 2-phenylethyl acetate.

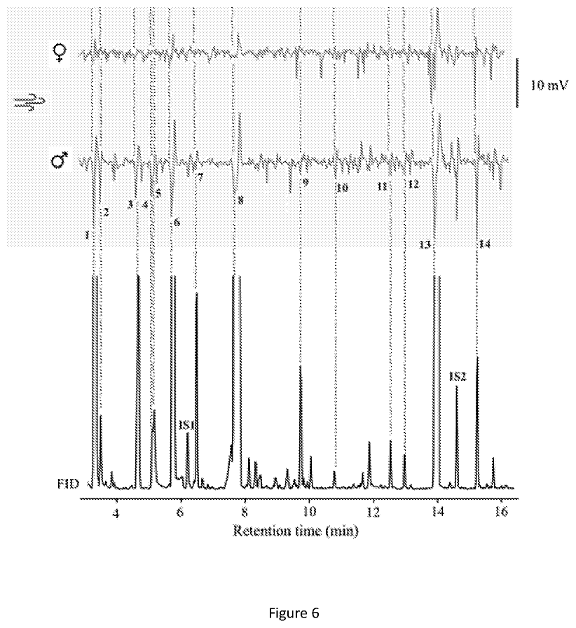

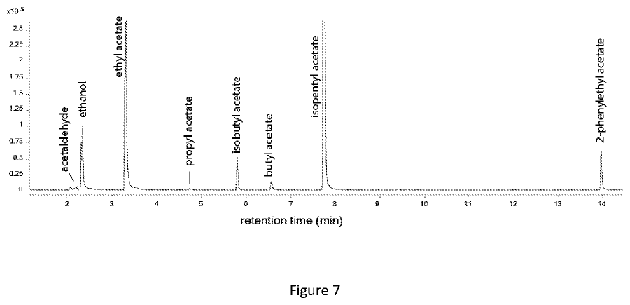

C. davidsoni sensitivity to the different compounds present in the odour of the attractive yeast P. kluyveri was tested using gas-chromatography coupled with electroantennography (GC-EAD). In total, 14 compounds elicited consistent responses with C. davidsoni (FIG. 6). Of these compounds, four are already present in the existing carpophilus lure (ethyl acetate, isobutyl alcohol, Isopentyl alcohol and 2-methyl-1-butanol) while responses to the two others (ethanol, acetaldehyde) also present in the headspace of P. kluyveri; could not be observed (covered by the solvent peak). However, beetles GC-EAD responses to these compounds were observed in another study (FIG. 7). Most of the other responses were elicited by esters (mostly ethyl esters, cyclic esters and acetates); including Isopentyl acetate and 2-phenyl ethyl acetate, and their amplitudes appeared widely dose-dependent. Volatiles collections and analysis conducted in parallel with electrophysiological studies (GC-EAD, FIG. 6) revealed a strong sensitivity of beetle antennae to two dominant esters in the yeast odour profile; namely Isopentyl acetate and 2-phenethyl acetate.

### Example 6—Field Testing of New Synthetic Blends to Attract Carpophilus Attacking Stone Fruits

Synthetic blends consisting of the combination of the existing carpophilus lure with two new potential yeast attractants; namely Isopentyl acetate and 2-phenylethyl acetate; were formulated based on their respective ratio to ethyl acetate (Table 2) and tested in the field.

Field trials were conducted in a peach orchard in Invergordon (Victoria). Treatments included the original carpophilus lure (CL: control), the original lure combined with Isopentyl acetate (CL+IA) or with 2-phenylethylacetate (CL+2PA) or both (CL+IA+2PA). Six replicates of each odour blend were placed in black funnel traps held on pickets at 1.5 m height, arranged in randomized transects. Beetles were collected and synthetic blends replaced weekly over a 5-week period.

These compounds were tested either separately or together in the existing Carpophilus co-attractant and compared with the original co-attractant in the field. The trial was conducted over a five week period during which the beetles were collected and the lure solutions renewed weekly. The lure compositions investigated are described in Table 2.

TABLE 2
Composition of the synthetic lures used as
treatments in stone fruit orchard trial.

| Treatments | Lure composition (vol/100 mL) |
|---|---|
| (CL) | Acetaldehyde: 65.4 μL |
| Carpophilus Lure | Ethanol : 44.3 ml |
| | Ethyl acetate: 104.4 μL |
| | Isobutanol: 33.8 μL |
| | Isopentyl alcohol: 74.1 μL |
| | *2-methyl-butanol: 24.4 μL |
| | Water: 55.4 mL |
| (CL + IA) | Acetaldehyde: 65.4 μL |
| Carpophilus Lure + | Ethanol : 44.3 mL |
| Isopentyl Acetate | Ethyl acetate: 104.4 μL |
| | Isobutanol: 33.8 μL |
| | Isopentyl alcohol: 74.1 μL |
| | 2-methyl-butanol: 24.4 μL |
| | *Isopentyl acetate: 142 μL |
| | Water: 55.4 mL |
| (CL + 2PA) | Acetaldehyde: 65.4 μL |
| Carpophilus Lure + | Ethanol : 44.3 mL |
| 2-Phenylethyl Acetate | Ethyl acetate: 104.4 μL |
| | Isobutanol: 33.8 μL |
| | Isopentyl alcohol: 74.1 μL |
| | 2-methyl-butanol: 24.4 μL |
| | *2-Phenylethyl acetate: 24 μL |
| | Water: 55.4 mL |
| (CL + IA & 2PA) | Acetaldehyde: 65.4 μL |
| Carpophilus lure + | Ethanol : 44.3 mL |
| Isopentyl Acetate + | Ethyl acetate: 104.4 μL |
| 2-Phenylethyl Acetate | Isobutanol: 33.8 μL |
| | Isopentyl alcohol: 74.1 μL |
| | 2-methyl-butanol: 24.4 μL |
| | *Isopentyl acetate: 124 μL |
| | *2-Phenylethyl acetate: 24 μL |
| | Water: 55.4 mL |

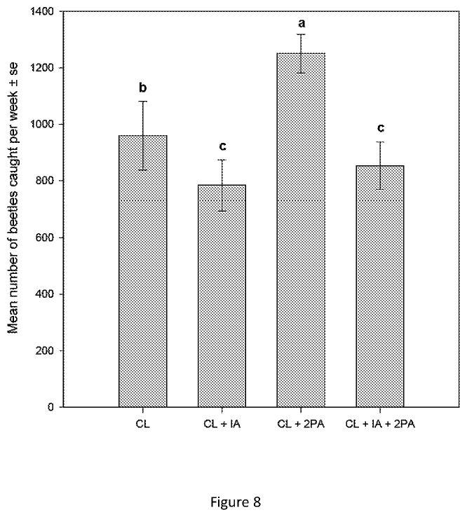

The co-attractant to which the yeast compound 2-phenethyl acetate was added was observed to result in the capture of significantly more beetles than the original co-attractant alone (FIG. 8). Further, the addition of isopentyl acetate (alone or in combination with 2-phenethyl acetate) to the co-attractant was observed to reduce lure attractiveness (FIG. 8).

Studies determining optimal sachet size and thickness, lure concentration, release rates and lure longevity were performed as described in Table 3. Results showed that 2-phenethyl acetate is suitable for dispensing in sachets and longevity can be extended to over 70 days.

TABLE 3
Sachet description, lure formulation, release rates and lure longevity (based on GC-MS
analysis) for all components used in field studies of Example 6.

| | Thickness | Size | Load | Est. long. | Release rate |
|---|---|---|---|---|---|
| Compound | (μm) | (cm) | (ml) | (days) | (mg/day) |
| acetaldehyde | 200 | 5 × 2.5 | 2 | 40 | 50 |
| ethyl acetate | 200 | 5 × 5 | 2 | 15 | 136 |
| Isobutyl alcohol | 50 | 2.5 × 2.5 | 1 | 200+ | 4.9 |
| Isopentyl alcohol | 50 | 2.5 × 2.5 | 1 | 300 | 3.4 |
| 2-methyl-butanol | 100 | 5 × 5 | 1 | 200+ | 4.3 |
| 2-phenylethylacetate | 50 | 5 × 5 | 2 | 70+ | 28 |

Ethanol applied as a 45% solution (200 ml) in 11-cm diameter plastic container.

### Example 7—Co-Attractant Compositions Targeting Carpophilus truncatus

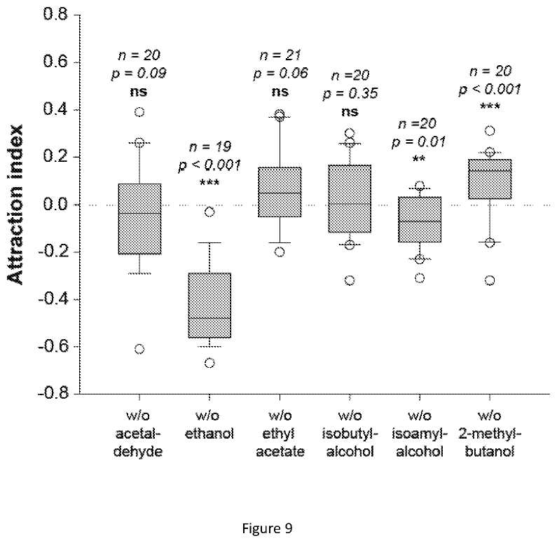

The commercially available carpophilus co-attractant exhibits some degree of attraction to C truncatus under laboratory and field conditions. The effect of volatiles within the existing co-attractant was therefore investigated in laboratory conducted bioassays (FIG. 9). Key attractants and repellents were identified leading to a simplified version of the existing co-attractant. Further lab testing showed that lure attraction could be augmented by varying the concentrations of one of the key attractants.

TABLE 4
Compositions of the test and control solutions used in cage bioassays

| | Test solutions | | Control | | |
|---|---|---|---|---|---|
| Experiment | Composition | Vol* | Composition | Vol* | |
| w/o | [symbol] | [symbol] | Acetaldehyde | 163.5 | μl |
| acetaldehyde | Ethyl acetate | 261 μL | Ethyl acetate | 261 | μL |
| vs | Isobutyl alcohol | 84.5 μl | Isobutyl | 84.5 | μl |
| CL | Isopentyl alcohol | 185.8 μl | alcohol | 185.8 | μl |
| | 2-methyl-butanol | 61 μl | Isopentyl | 61 | μl |

| | | | | |
|---|---|---|---|---|
| | In ethanol | 45% | alcohol | 45% |
| w/o ethanol | Acetaldehyde | 163.5 μl | 2-methyl- | |
| vs | Ethyl acetate | 261 μL | butanol | |
| CL | Isobutyl alcohol | 84.5 μl | In ethanol | |
| | Isopentyl alcohol | 185.8 μl | | |
| | 2-methyl-butanol | 61 μl | | |
| | In water | | | |
| w/o Isobutyl | Acetaldehyde | 163.5 μl | | |
| alcohol | Ethyl acetate | 261 μL | | |
| vs | [symbol] | [symbol] | | |
| CL | Isopentyl alcohol | 185.8 μl | | |
| | 2-methyl-butanol | 61 μl | | |
| | In ethanol | 45% | | |
| w/o Isopentyl | Acetaldehyde | 163.5 μl | | |
| alcohol | Ethyl acetate | 261 μL | | |
| vs | Isobutyl alcohol | 84.5 μl | | |
| CL | [symbol] | [symbol] | | |
| | 2-methyl-butanol | 61 μl | | |
| | In ethanol | 45% | | |
| w/o 2-methyl- | Acetaldehyde | 163.5 μl | | |
| butanol | Ethyl acetate | 261 μL | | |
| vs | Isobutyl alcohol | 84.5 μl | | |
| CL | Isopentyl alcohol | 185.8 μl | | |
| | [symbol] | [symbol] | | |
| | In ethanol | 45% | | |

Fifty beetles were simultaneously exposed to a solution of co-attractant (control) and a solution of co-attractant from which one additive at a time was suppressed (treatments, see table 4). The attraction index was calculated as follows: (number of beetles in test solution—number of beetles in control)/(total number of beetles). Hence, positive indices indicate preferences for the test solution whilst negative indices indicate preference for the control (original carpophilus co-attractant) (FIG. 9)

Cage experiments demonstrated that the commercial co-attractant was significantly less attractive in the absence of ethanol and Isopentyl alcohol which appear to be the main attractants. In addition the co-attractant was significantly more attractive in the absence of 2-methylbutanol thus demonstrating its repellent effect. Acetaldehyde did tend to act as an attractant though this could not be clearly demonstrated in subsequent experiments whilst ethyl acetate and isobutyl alcohol seem to not influence beetle's orientation. Hence, the co-attractant chosen for testing in the field consisted of a reduced version of the commercial attractant comprising only Isopentyl alcohol in 45% ethanol.

Further cage bioassay experiments showed that increased concentrations of Isopentyl alcohol contribute to an increase in lure efficacy. Therefore, different concentrations of this compounds were tested in the field.

### Example 8—Design of Yeast-Derived Co-Attractant Mixture

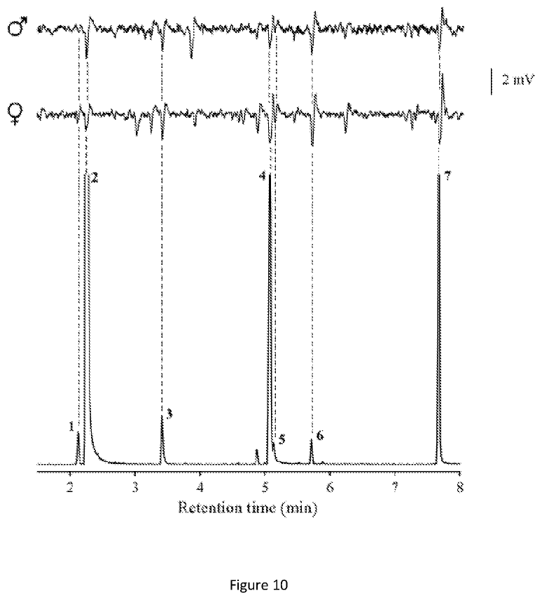

As co-attractants are derived from microbial odours, beetle attraction towards yeast odours isolated from the insect's gut was tested (Farrukh Baig, PhD thesis, 2020). The results demonstrated that C. truncatus is strongly attracted to the odour of the yeast Wickerhamomyces rabaulensis. Chemical analysis of the yeast headspace revealed strong similarities in composition with the commercial co-attractant. However, components occurred at ratios differing from those of the commercial solutions, and in addition other candidate attractants were identified by electrophysiological techniques (GC-EAD) (FIG. 10). Synthetic blends of the yeast odours were developed and field tested.

The headspace odour of W. rabaulensis was observed to comprise almost all the compounds from the co-attractant except ethyl acetate. In addition, Isopentyl acetate and isobutyl acetate accounted for a significant part of the odour profile and elicited strong antennal responses from beetles.

A synthetic blend of the observed composition was used for field testing at low and high (×30) concentrations (See Example 10). The effect of the two esters was tested in the yeast blend formulation and also in combination with the commercial co-attractant in two separate trials (See Examples 9 and 10).

### Example 9—Field Trials of Modified Co-Attractant Mixture, for Attracting Carpophilus truncatus (Almond Beetle)

In the first field trial, the reduced version of the commercial attractant was evaluated both in solution and in its sachet version, with each treatment being replicated 12 times (6 reps at two field sites). The commercial formulation of the co-attractant (CL) was used as a control (Table 5).

TABLE 5
Composition of the test co-attractants developed using laboratory bioassays and tested in
the field.

| Treatments | Lure composition | Liquid base |
|---|---|---|
| CL (control) | Acetaldehyde: 65.4 μL /100 ml | 250 ml of a solution of |
| | Ethyl acetate: 104.4 μL / 100 ml | ethanol:water (45:55) |
| | 2-methylpropan-1-ol: 33.8 μl /100 ml | |
| | Isopentyl alcohol: 74.3 μl / 100 ml | |
| | 2-methyl-butanol: 24.4 μl /100 ml | |
| [Isopentyl- | Isopentyl alcohol: 150 μl / 100 ml | |
| OH] × 2 | | |
| (solution) | | |
| [Isopentyl- | Isopentyl alcohol: 2 sachets (50 μm, 2.5 × 2.5 | |
| OH] × 2 (sachet) | cm, 1 ml load) | |

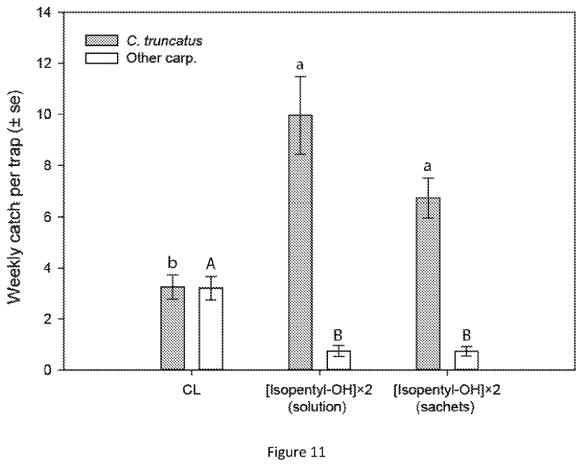

It was observed that traps baited with Isopentyl alcohol prepared in 45% ethanol caught significantly more C. truncatus beetles compared to the commercial co-attractant. In addition, the number of non-target species individuals was significantly lower than with the original solution (FIG. 11).

In a subsequent trial, the reduced co-attractant was assessed using a higher concentration of Isopentyl alcohol. The best performing solution in the previous trial was, this time used as control (Table 6). Treatments were replicated 12 times in total (6 reps in two field sites).

TABLE 6
Composition of variants of the reduced co-attractant formulated in solution and sachet

| Treatments | Lure composition | Liquid base |
|---|---|---|
| [Isopentyl-OH]*2 (solution) - | Isopentyl alcohol: 150 μl / 100 ml | 250 ml of a solution of |
| control | | ethanol:water (45:55) |
| [Isopentyl-OH]*6 (solution) | Isopentyl alcohol: 450 μl / 100 ml | |
| [Isopentyl-OH]*6 (sachet) | Isopentyl alcohol: 1 sachet (50 μm, | |
| | 5 × 5 cm, 2 ml load) | |

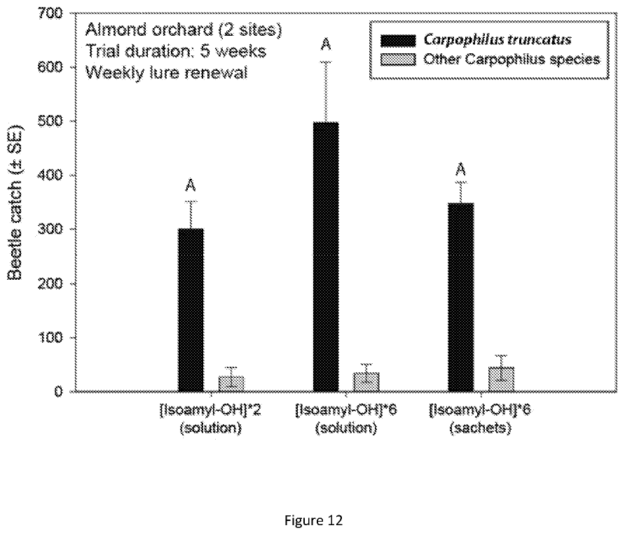

There was no significant difference observed between the reduced co-attractant and the reduced co-attractant containing a higher concentration of Isopentyl alcohol. However, there appears to be a clear trend for greater catches with the more concentrated lure (FIG. 12).

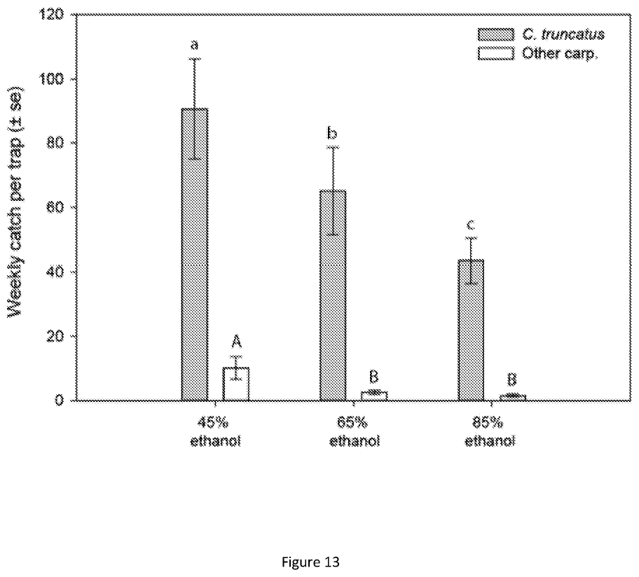

In another trial conducted in almond orchards the simplified co-attractant was tested at different ethanol concentrations and confirmed 45-50%, corresponding to that of the original co-attractant, as optimal (see Table 7 and FIG. 13).

TABLE 7
Lure composition using different concentrations of ethanol in the simplified co-attractant

| Treatment | Lure composition | Liquid base |
|---|---|---|
| 45% EtOH | Isopentyl alcohol: 150 μl / 100 ml | 250 ml ethanol:water (45:55) |
| 65% EtOH | Isopentyl alcohol: 150 μl / 100 ml | 250 ml ethanol:water (65:35) |
| 85% EtOH | Isopentyl alcohol: 150 μl / 100 ml | 250 ml ethanol:water (85:15) |

### Example 10—Fungal Additive Composition Trials for Attracting Carpophilus truncatus (Almond Beetle)

Synthetic blends of the attractive yeast W. raubulensis were assessed at two different concentrations: a concentration that corresponds to natural volatiles emissions of cultured yeasts (Wr low) and a more concentrated blend adjusted to match the ethanol concentration of the co-attractant whilst preserving the ratios of other components of the blend (Wr high). In a last treatment, the two newly identified yeast esters (Isopentyl acetate and isobutyl acetate) were added to the original co-attractant (Table 8). Each treatment was replicated 12 times in total (6 reps in two field sites).

TABLE 8
Test treatments involving volatiles synthetic blends
of the yeast W. rabaulensis.

| Treatments | Lure composition | Liquid base |
|---|---|---|
| CL | Acetaldehyde: 65.4 μl /100 ml | 250 ml of a |
| (Control) | Ethyl acetate: 104.4 μL / 100 ml | solution of |
| | 2-methylpropan-1-ol: 33.8 μl /100 ml | ethanol:water |
| | Isopentyl alcohol: 74.1 μl / 100 ml | (45:55) |
| | 2-methyl-butanol: 24.4 μl /100 ml | |
| Wr (Low) | Acetaldehyde: 5.4 μl /100 ml | 250 ml of a |
| | 2-methylpropan-1-ol: 0.83 μl /100 ml | solution of |
| | Isopentyl alcohol: 3.53 μl /100 ml | ethanol:water |
| | 2-methyl-butanol: 0.15 μl /100 ml | (1.5%) |
| | Isopentyl acetate: 0.015 μl /100 ml | |
| | Isobutyl acetate: 0.1 μL / 100 ml | |
| Wr (High) | Acetaldehyde: 162 μl /100 ml | 250 ml of a |
| | 2-methylpropan-1-ol: 24.8 μl /100 ml | solution of |
| | Isopentyl alcohol: 105.8 μl /100 ml | ethanol:water |
| | 2-methyl-butanol: 4.53 μl /100 ml | (45:55) |
| | Isopentyl acetate: 0.45 μl /100 ml | |
| | Isobutyl acetate: 3 μL / 100 ml | |
| CL + esters | Acetaldehyde: 65.4 μl /100 ml | 250 ml of a |
| | Ethyl acetate: 104.4 μL / 100 ml | solution of |
| | 2-methylpropan-1-ol: 33.8 μl /100 ml | ethanol:water |
| | Isopentyl alcohol: 74.1 μl / 100 ml | (45:55) |
| | 2-methyl-butanol: 24.4 μl /100 ml | |
| | Isopentyl acetate: 0.45 μl /100 ml | |
| | Isobutyl acetate: 3 μL / 100 ml | |

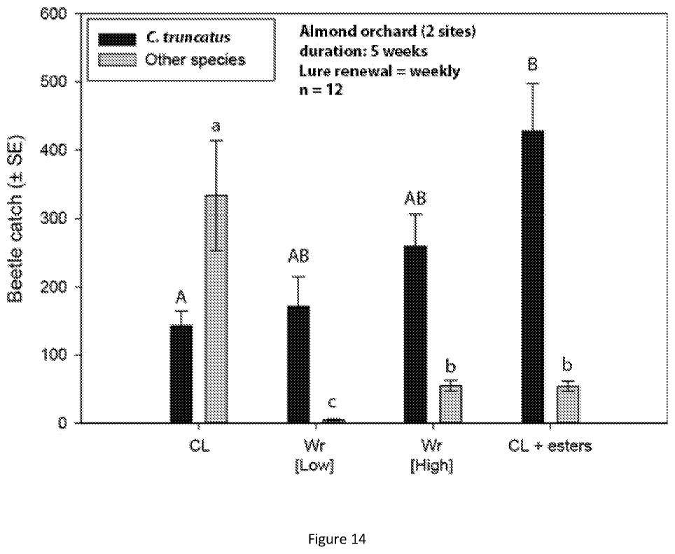

The two yeast blends demonstrated a trend for attracting more beetles than the original carpophilus lure (FIG. 14), especially at greater concentrations. However, the lure combining the new esters with the original co-attractant caught significantly more C. truncatus.

A further field trial aimed to evaluate the influence of the two new esters on C. truncatus attraction in the W. rabaulensis yeast blend. Wr [high] treatment used in previous trial was tested with and without these esters and compared with the commercial co-attractant (CL) used as control (Table 9). Each treatment was replicated 10 times in total (5 reps in two field sites). The error bars represent the standard error.

TABLE 9
Lure composition of treatments used to test the influence of yeast esters.

| Treatments | Lure composition | Liquid Base |
|---|---|---|
| CL | Acetaldehyde: 65.4 μl /100 ml | 250 ml ethanol: |
| | Ethyl acetate: 104.4 μL / 100 ml | water |
| | 2-methylpropan-1-ol: 33.8 μl /100 ml | (45:55) |
| | Isopentyl alcohol: 74.3 μl / 100 ml | |
| | 2-methyl-butanol: 24.4 μl /100 ml | |
| Wr adj. | Acetaldehyde : 137 μL / 100 ml | |
| | 2-methylpropan-1-ol: 21 μL / 100 ml | |
| | Isopentyl alcohol: 90 μL / 100 ml | |
| | 2-methyl-butanol: 4 μl /100 ml | |
| | Isobutyl acetate: 0.4 μl/100 ml | |
| | Isopentyl acetate: 2.5 μL / 100 ml | |
| Wr adj. w/o esters | Acetaldehyde : 137 μL / 100 ml | |
| | 2-methylpropan-1-ol: 21 μL / 100 ml | |
| | Isopentyl alcohol: 90 μL / 100 ml | |
| | 2-methyl-butanol: 4 μl /100 ml | |

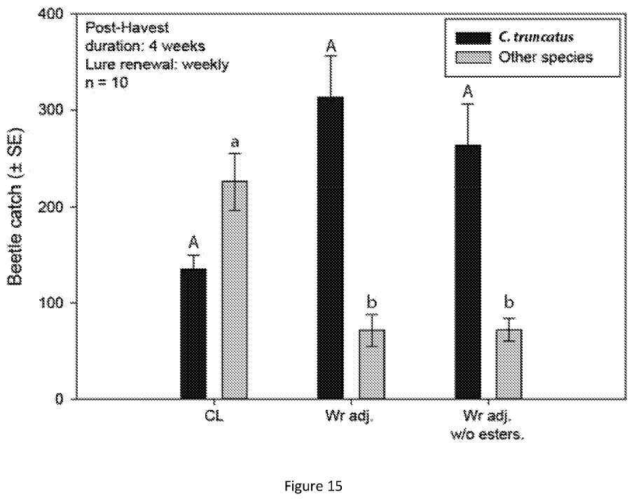

The yeast-derived blend tended was observed to result in the capture of more C. truncatus and less of other beetle species than the original co-attractant (FIG. 15). While esters increased beetle catches, compound ratios of the yeast blend alone appeared to already increase lure efficacy and specificity (FIG. 15).

### Example 11—Trial Comparing Fungal-Derived Blends with Simplified Co-Attractants (“Ref”) for Attracting C. truncatus (Almond Beetle)

The best yeast-derived blend and some variants of differing concentrations of ethyl acetate and esters were compared with the simplified co-attractant (comprising only ethanol and isopentyl alcohol) and simplified co-attractants combined to yeast esters (Table 10).

TABLE 10
Test treatments involving volatiles synthetic blends of the yeast W. rabaulensis, the
simplified co-attractant and combinations of the two.

| Treatments | Composition | Liquid base | Pheromones |
|---|---|---|---|
| CL + EA + | Acetaldehyde: 65.4 μl /100 ml | ethanol:water | no |
| Esters | Ethyl acetate: 104.4 μL / 100 ml | (45:55) | |
| | 2-methylpropan-1-ol: 33.8 μl /100 ml | 250 ml / trap | |
| | Isopentyl alcohol: 74.3 μl / 100 ml | | |
| | 2-methyl-butanol: 24.4 μl /100 ml | | |
| | Isobutyl acetate: 3 μl / 100 ml | | |
| | Isopentyl acetate: 0.45 μL / 100 ml | | |
| CL + EA | Acetaldehyde: 65.4 μl /100 ml | | |
| (Wr) + | Ethyl acetate: 20 μL / 100 ml | | |
| Esters | 2-methylpropan-1-ol: 33.8 μl /100 ml | | |
| | Isopentyl alcohol: 74.3 μl / 100 ml | | |
| | 2-methyl-butanol: 24.4 μl /100 ml | | |
| | Isobutyl acetate: 3 μl / 100 ml | | |
| | Isopentyl acetate: 0.45 μL / 100 ml | | |
| Ref | Isopentyl alcohol: 400 μL / 100 ml | | |
| Ref + EA + | Isopentyl alcohol: 400 μL / 100 ml | | |
| esters | Ethyl acetate: 104.4 μL / 100 ml | | |
| | Isobutyl acetate: 3 μl / 100 ml | | |
| | Isopentyl acetate: 0.45 μL / 100 ml | | |
| Ref + EA | Isopentyl alcohol: 400 μL / 100 ml | | |
| (Wr) + | Ethyl acetate: 20 μL / 100 ml | | |
| esters | Isobutyl acetate: 3 μl / 100 ml | | |
| | Isopentyl acetate: 0.45 μL / 100 ml | | |
| CL + EA + | Acetaldehyde: 65.4 μl /100 ml | | |
| Esters*3 | Ethyl acetate: 104.4 μL / 100 ml | | |
| | 2-methylpropan-1-ol: 33.8 μl /100 ml | | |
| | Isopentyl alcohol: 74.3 μl / 100 ml | | |
| | 2-methyl-butanol: 24.4 μl /100 ml | | |
| | Isobutyl acetate: 9 μl / 100 ml | | |
| | Isopentyl acetate: 1.35 μL / 100 ml | | |
| Ref + EA + | Isopentyl alcohol: 400 μL / 100 ml | | |
| esters*3 | Ethyl acetate: 104.4 μL / 100 ml | | |
| | Isobutyl acetate: 9 μl / 100 ml | | |
| | Isopentyl acetate: 1.35 μL / 100 ml | | |

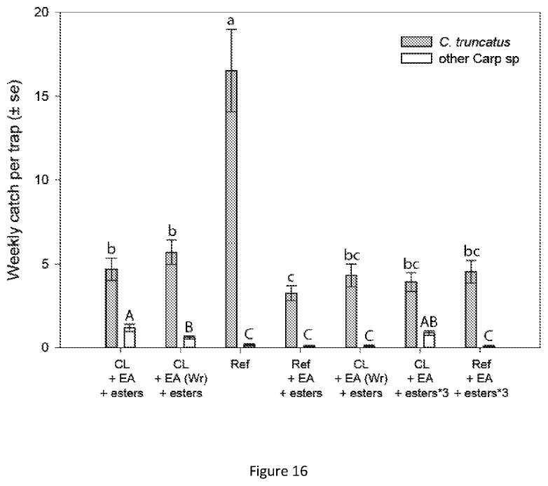

The simplified co-attractant (Ref) was observed to result in the capture of three to four-fold more C. truncatus than any other treatment (FIG. 16). The addition of ethyl acetate and the yeast esters to the simplified solution considerably reduced the number of captured beetles suggesting the existence of an antagonistic effect between these compounds and Isopentyl alcohol. In addition, the simplified co-attractant yielded significantly lower captures non-target carpophilus species than the other treatments.

### Example 12—Trial Comparing the Simplified 2-Component Co-Attractant (“Ref”) with the Commercially Available Co-Attractant (“CL”) in the Presence of Synthetic Commercial Pheromones

The simplified co-attractant (“Ref”, including isopentyl alcohol and ethanol) and the original commercially available co-attractant solutions were tested in the presence of the commercial carpophilus pheromones (Table 11).

TABLE 11
Test treatments involving the simplified and original attractants tested in the presence of
commercial synthetic pheromones.

| Treatments | Composition | Liquid base | Pheromones |
|---|---|---|---|
| Ref + Phero | Isopentyl alcohol: 400 μL / 100 ml | ethanol:water | 1 trispecies |
| CL + Phero | Acetaldehyde: 65.4 μl /100 ml | (45:55) | septum |
| | Ethyl acetate: 104.4 μL / 100 ml | 250 ml / trap | |
| | 2-methylpropan-1-ol: 33.8 μl / 100 ml | | |
| | Isopentyl alcohol: 74.3 μl / 100 ml | | |
| | 2-methyl-butanol: 24.4 μl /100 ml | | |

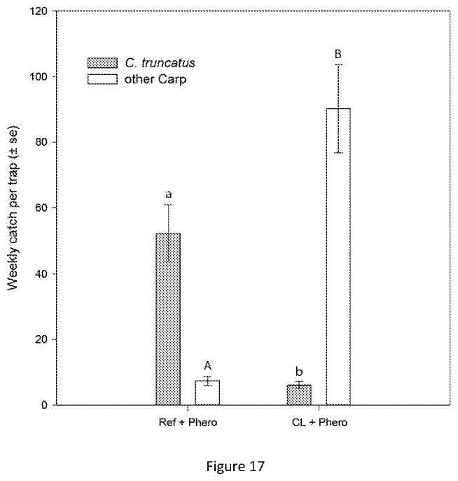

The simplified co-attractant was observed to increase by eight to ten times the capture of C. truncatus (FIG. 17) compared to the original solution which attracted significantly more non-target species (predominantly C. hemipterus). Hence, the greater capture and specificity of the simplified co-attractant was proved to be more specific and therefore more suitable for use in “attract & kill” and monitoring of C. truncatus.

### Example 13—Optimization of the Concentration of Isopentyl Alcohol in the Simplified Co-Attractant (“Ref”)

Different concentrations of isopentyl alcohol prepared in 45% ethanol were tested in a field trial to determine the optimal concentration to use in the simplified co-attractant (Table 12).

TABLE 12
Test treatments involving the simplified co-attractant (“Ref”, including isopentyl alcohol and
ethanol) with varying concentrations of isopentyl alcohol.

| Treatment | Composition | Liquid base | Pheromones |
|---|---|---|---|
| Ref | Isopentyl alcohol: 400 μL / 100 ml | ethanol: water | no |
| Ref × 2 | Isopentyl alcohol: 800 μL / 100 ml | (45:55) | |
| Ref × 3 | Isopentyl alcohol: 1.4 mL / 100 ml | 250 ml / trap | |

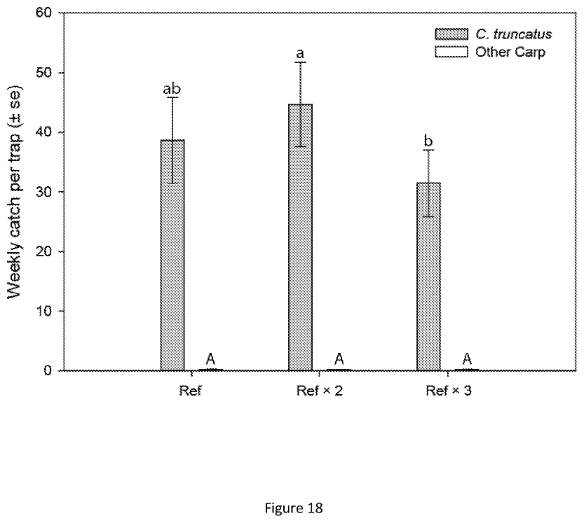

Co-attractant solutions in which the concentration of isopentyl alcohol was doubled (Ref×2) tended to catch more C. truncatus than the reference solution (Ref) and significantly more than the co-attractant in which the concentration of isopentyl alcohol was tripled (Ref×3) (FIG. 18). All solutions yielded negligible captures of non-target carpophilus species. The results indicate that doubling the concentration of isopentyl alcohol may yield significantly greater C. truncatus captures over longer trapping periods.

### REFERENCES

Bartelt R J, Hossain M S (2006) Development of synthetic food-related attractant for Carpophilus davidsoni and its effectiveness in the Stone Fruit orchards in Southern Australia. J Chem Ecol 32:2145-2162. doi: 10.1007/s10886-006-9135-7.
Hossain M S, Bartelt R J, Hossain M A B M, et al (2008) Longevity of pheromone and co-attractant lures used in attract-and-kill stations for control of Carpophilus spp. Entomol Exp Appl 129:148-156. doi: 10.1111/j.1570-7458.2008.00769.x.
Torr S J, Hall D R, Phelps R J, Vale G A (1997) Methods for dispensing odour attractants for tsetse flies (Diptera: Glossinidae). Bull Entomol Res 87:299-311.
Baig F et al. (2020) Yeasts Influence Host Selection and Larval Fitness in Two Frugivorous Carpophilus Beetle Species. J Chem Ecol. 46: 675-687.
Baig F et al. (2020) Chemical ecology of Carpophilus beetles and their yeast symbionts. PhD thesis. Queensland University of Technology. (Published 25 Aug. 2020).

1-28. (canceled)

29. A composition for attracting Carpophilus beetles, said composition including:
ethanol, and
a co-attractant mixture including one or more compounds selected from acetaldehyde, ethyl acetate, isobutanol, isopentyl alcohol, and 2-methylbutanol, wherein said composition is a liquid and/or gas mixture;
wherein the co-attractant mixture includes one or more compounds selected from:
acetaldehyde at a concentration of between approximately 5 μl and 170 μl/100 ml of corn position,
ethyl acetate at a concentration of between approximately 75 μl and 125 μl/100 ml of composition,
isobutanol at a concentration of between approximately 0.1 μl and 50 μl/100 ml of composition,
2-methyl-butanol at a concentration of between approximately 0.1 μl and 40 μl/100 ml of composition, and
isopentyl alcohol at a concentration of between approximately 0.01 μl and 1750 μl per 100 ml of composition.

30. A composition according to claim 29, wherein the composition further includes one or more fungal additives.

31. A composition according to claim 30, wherein the one or more fungal additives are produced by yeast of the genus Wickerhamomyces, Pichia or Hanseniaspora.

32. A composition according to claim 31, wherein the one or more fungal additives are from the yeast species Wickerhamomyces rabaulensis, Pichia kluyveri or Hanseniaspora guillermondii.

33. A composition according to claim 30, wherein the one or more fungal additives are selected from isobutyl acetate, isopentyl acetate, 2-phenylethylpropionate, and 2-phenethyl acetate.

34. A composition according to claim 30, wherein the composition includes one or more fungal additives selected from:
isobutyl acetate at a concentration of between approximately 0.05 μl and 5 μl/100 ml of composition,
isopentyl acetate at a concentration of between approximately 0.01 μl and 150 μl/100 ml of composition, or
2-phenethyl acetate at a concentration of between approximately 15 μl and 30 μl/100 ml of composition.

35. A composition according to claim 30, wherein the fungal additive(s) and co-attractant mixture are present at a ratio of between approximately 1:2 and 1:100 (v/v).

36. A composition according to claim 29, wherein the ethanol is an aqueous ethanol solution.

37. A composition according to claim 36, wherein the aqueous ethanol is between approximately 30 to 85% ethanol.

38. A composition according to claim 29, wherein the concentration of isopentyl alcohol is between approximately 50 μl and 1500 μl/100 ml of composition.

39. An apparatus for dispensing the composition according to claim 29.

40. An apparatus according to claim 39, wherein the apparatus provides for regulated release of the composition.

41. A device for trapping Carpophilus beetles including a composition according to claim 29.

42. A method of attracting and/or trapping Carpophilus beetles including the step of exposing a Carpophilus beetle infested environment to a composition according to claim 29.

43. A method of monitoring for the presence of at least one Carpophilus beetle including positioning a composition according to claim 29, within an environment that requires monitoring for the presence of Carpophilus beetles.

44. A composition consisting of isopentyl alcohol and aqueous ethanol and optionally one or more fungal additives.

45. A composition according to claim 29 wherein the fungal additives are selected from isopentyl acetate and/or isobutyl acetate.

46. A composition according to claim 29 consisting of isopentyl alcohol and aqueous ethanol.

47. A composition according to claim 29 wherein the aqueous ethanol is between approximately 30 to 65% ethanol.

48. A composition according to claim 29 wherein the isopentyl alcohol is present in a concentration of between 400 and 1500 μL/100 mL of composition.
